(19) United States
(12) Patent Application Publication
(10) Pub. No.: US 2005/0102994 A1
(43) Pub. Date: May 19, 2005

(54) Provision of sealing for the cabin-air bleed cavity of a jet engine using a brush seal

(75) Inventors: Gilles Lepretre, Epinay Sous Senart (FR); Laurent Marnas, Vaux Le Penil (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, PARIS (FR)

(21) Appl. No.: 10/938,571

(22) Filed: Sep. 13, 2004

(30) Foreign Application Priority Data
Sep. 19, 2003 (FR) 03 11021

(51) Int. Cl. F02C 3/00; F02G 3/00

(52) U.S. Cl. 60/39.01

(57) ABSTRACT

The invention relates to the sealing of the cavity for bleeding air to the cabin, which cavity is delimited, on the one hand, by the external shell of the compressor and an annular structure connected to the shell, and, on the other hand, by the external casing of the diffuser grating and a strut connected to said external casing and to an external engine casing shell, this external casing shell being fastened to the annular structure by bolting together flanges, using sealing means provided between the annular structure and the external casing of the diffuser grating, wherein the sealing means consist of a brush seal fastened to the periphery of the upstream part of the external casing of the diffuser grating, said seal having bristles which extend radially outward and bear against the internal surface of a cylindrical sleeve which is integral with the annular structure and surrounds said brush seal.

The invention relates to a jet engine comprising, from upstream to downstream (the upstream and downstream directions being defined by the direction of circulation of the primary flow), a high-pressure compressor, a diffuser grating and a combustion chamber, said high-pressure compressor comprising an external shell which radially delimits the duct for said primary flow and is connected to an annular structure extending radially outward, said diffuser grating comprising in the axial continuation of said external compressor shell an external casing connected to a rearwardly oriented conical strut delimiting, upstream, the end of said combustion chamber, said strut itself being connected to an external casing shell which extends in the upstream direction and is fastened to said annular structure by fastening means, said strut, said external casing shell and said annular structure defining a cavity around said diffuser grating, air bleed orifices being made in said strut in order to is bring the end of the combustion chamber into communication with said cavity, said external casing shell being equipped with outlet vents for the bled air, and sealing means being provided between said annular structure and said external diffuser grating casing in order to isolate said cavity from the duct for the primary flow.

Air required for the cabin of the airplane equipped with at least one jet engine is bled off at the end of the combustion chamber in a region where it has the least disruptive effect on the overall efficiency of the engine. Bleeding takes place through the orifices in the strut, which makes it easy to install the outlet vents for the bled air. This arrangement requires relative sealing between the duct of the high-pressure compressor and the cavity situated above the grating of the diffuser.

This sealing is all the more difficult to achieve because the relative displacements between the diffuser grating and the external shell of the compressor are of the order of 1.5 mm in the axial direction and substantially of the same order in the radial direction, owing to the thermal and mechanical responses of the various components in an environment subjected to high pressures which may reach 30 bar and to high temperatures which may reach 650° C.

The current technology adopted to provide sealing between the compressor and the external casing of the grating is of the type comprising a seal made up of a strip and counterseal with springs pressing against these. This technology in fact allows a sufficiently large displacement between the two components.

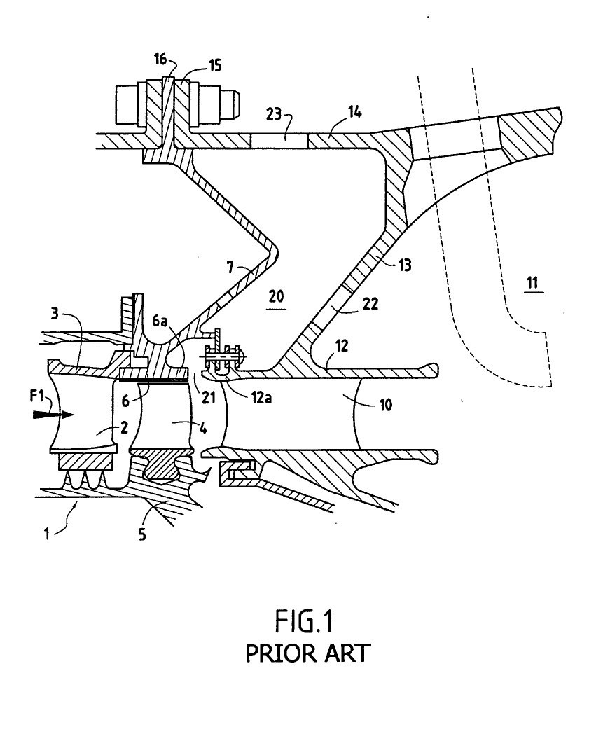

The prior art is illustrated by FIG. 1, which shows the last stage of a high-pressure compressor 1 of a jet engine having, from upstream to downstream in the direction of the primary flow Fl, a ring of fixed vanes 2 extending radially inward from an external casing 3, followed by a ring of moving blades 4 mounted at the periphery of a compressor wheel 5 and extending outward as far as an external compressor shell 6 which, together with the external casing 3, radially delimits the duct for the primary flow, this external shell 6 being connected to an annular structure 7 which has a V-shaped cross section in the plane containing the axis of the jet engine and extending radially outward and is fastened to the external casing of the engine by bolting.

Provided downstream of the compressor 1 is a diffuser grating 10 which receives the compressed air from the compressor 1 and delivers it toward a combustion chamber 11. In the axial continuation of the external shell 6 of the compressor 1, the grating 10 has an external casing 12 connected to a conical strut 13 oriented toward the rear of the jet engine, this strut 13 defining the upstream wall of the end of the combustion chamber 11 and being connected in its radially outer region to an external casing shell 14 which extends in the upstream direction and has an upstream flange 15 by means of which the assembly consisting of the combustion chamber and the diffuser can be fastened on a radially outer flange 16 of the annular structure 7 by bolting.

A cavity 20 surrounding the diffuser grating 10 is thus delimited axially by the annular structure 7 and the strut 13, radially outwardly by the external casing shell 14 and radially inwardly by the downstream portion 6a of the external compressor shell 6 and by the upstream portion 12a of the external casing 12, a gap 21 separating these two portions.

The strut 13 has air bleed orifices 22 at the end of the combustion chamber and the external casing shell 14 is equipped with outlet vents 23 to supply a flow of air for aerating the cabin of the airplane or for cooling other elements of the jet engine.

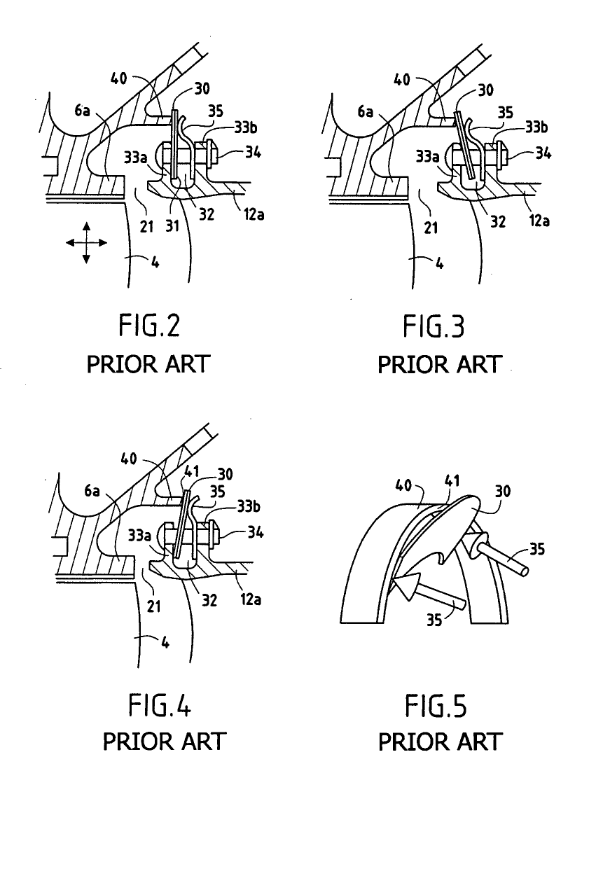

Sealing between the compressor duct and the cavity 20 is achieved, as is shown in detail in FIG. 2, by a sectorized seal made up of strips 30 lined with counterseals 31, this seal being mounted on the periphery of the upstream portion 12a of the external casing 12 of the diffuser grating. To this end, this upstream portion 12a has over its periphery a channel 32 delimited by two flanges, the upstream one having the reference 33a and the downstream one having the reference 33b, which flanges have holes drilled into them for fastening rivets 34. The strips 30 and the counterseals 31 are kept in bearing contact with the downstream face of the upstream flange 33a by means of springs 35 and are retained by the rivets 34. The springs 35 are likewise retained by the rivets 34. The radially internal portion of the annular structure 7 has an annular projection 40 which extends axially into the cavity 20 and the end of which is situated above the upstream flange 33a in the absence of any axial displacement between the external shell 6 of the compressor 1 and the external casing 12 of the diffuser, as is shown in FIG. 2.

The springs 35 bear on the seals in the annular region separating the projection 40 from the upstream flange 33a. Moreover, the air pressure in the cavity 20 is slightly greater than the pressure in the duct at the gap 21.

The bearing points for the seals 30 on the projection 40 side and on the upstream flange 33a side have convex surfaces. The combined forces of the springs 35 and the pressure difference across the two faces of the seals 30 press the strips 30, which are flat, against these surfaces in the configuration shown in FIG. 2, thus providing sealing.

In certain flight phases, the bearing between the strips 30 and the projection 40 leaves an escape clearance, especially when the projection 40 passes above the channel 32, as is shown in FIGS. 4 and 5. Between two consecutive springs, the strips 30 move away from the projection and only the pressure difference between the two faces, which is small, may prevent the creation of this separation. An escape clearance 41 is then formed between the strips and the end of the projection 40.

When, by contrast, the diffuser grating 10 moves away from the compressor 1, as can be seen in FIG. 3, the force due to the pressure difference and the force of the springs 35 allow correct sealing to be achieved, by deformation of the strips 30.

The double arrows shown in FIG. 2 indicate the relative axial and radial displacements between the downstream end of the external compressor shell 6 and the upstream end of the external casing 12 of the diffuser grating 10.

It should also be noted that the arrangement of this sealing system borne by the external casing 12 makes it possible for the combustion chamber/diffuser assembly to be assembled on the compressor by relative axial displacement of said assembly with respect to the compressor and then by bolting together the external flanges 15 and 16.

The aim of the invention is to propose a jet engine, as mentioned in the introduction, in which sealing is provided between the cavity for bleeding air to the cabin and the duct for the primary flow in the compressor, irrespective of the relative position between the external shell of the compressor and the external casing of the diffuser grating.

The invention achieves its aim by virtue of the fact that the sealing means consist of a brush seal fastened to the periphery of the upstream part of the external casing of the diffuser grating, said seal having bristles which extend radially outward and bear against the internal surface of a cylindrical sleeve which is integral with the annular structure and surrounds said brush seal.

The use of brush seals in turbomachines is known per se, but this type of seal has never been used to provide sealing of the cavity situated between the compressor and the diffuser/combustion chamber assembly.

Sealing is achieved through the density of the bristles and through their flexibility, which allows them to bear in an optimum manner on the sleeve irrespective of the relative position between the sleeve and the external casing.

The brush seal may or may not be sectorized. It may be fastened to the external casing in a number of ways.

According to a first embodiment, the upstream part of the external casing has a groove at its periphery, and the seal is fastened into the groove by fastening means.

According to a second embodiment, the brush seal is fastened by fastening means into the peripheral groove of a ring having a U-shaped cross section, and said ring is fastened by welding to the periphery of the upstream part of the external casing of the diffuser grating.

According to a third embodiment, the brush seal has a metal ring in its radially inner region, and said ring is fastened by welding to the periphery of the upstream part of said external casing.

Other advantages and features of the invention will emerge on reading the description below given by way of example and with reference to the appended drawings, in which:

FIGS. 1 to 5 show the prior art:

FIG. 1 being a half-section, in a plane containing the axis of the jet engine, of the downstream part of a compressor and of the diffuser, which shows the layout of the cavity communicating with the end of the combustion chamber and from which air is bled for the cabin of the airplane, and the installation of the seal, according to the prior art, between this cavity and the duct for the primary flow;

FIG. 2 shows the arrangement of the seal according to the prior art on a larger scale;

FIG. 3 shows the deformation of the seal when there is an increase in the gap between the external shell of the compressor and the external casing of the grating of the diffuser;

FIG. 4 shows the deformation of this same seal when there is a reduction in this gap; and

FIG. 5 is a perspective view of the seal when there is a reduction in the gap, which shows the escape clearance;

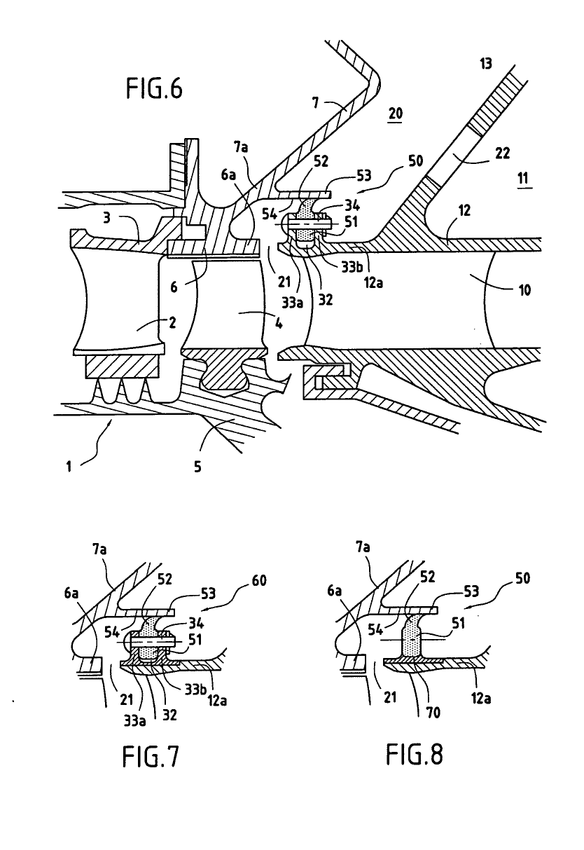

FIG. 6 is a cross-sectional view of the region outside the duct for the primary flow, situated between the compressor and the diffuser, and shows the sealing system of the brush seal type according to a first embodiment of the invention;

FIG. 7 shows a second embodiment of the invention; and

FIG. 8 shows a third embodiment of the invention.

The prior art illustrated by FIGS. 1 to 5 has already been commented upon and does not require any further explanations.

FIGS. 6 to 8 show a sealing device 50 of the brush seal type arranged between the radially inner part 7a of the annular structure 7, substantially parallel to the strut 13, and the upstream part 12a of the external casing of the diffuser grating 10. In these FIGS. 6 to 8, the parts or elements which are identical to those of FIGS. 1 to 5 bear the same references.

FIG. 6 shows a first embodiment of the invention. At its periphery the upstream part 12a of the external casing 12 has an upstream flange 33a and a downstream flange 33b which delimit between them a channel 32 into which the radially inner portion 51 or body of a brush seal is fastened by means of rivets 34, the brush seal having outwardly extending bristles 52. The body 51 may be produced either in the form of sectors or in the form of a split ring, and its width is dependent on the width of the channel 32 so that, after positioning the rivets 34, sealing is provided around the channel 32.

The projection 40 of the prior art illustrated in FIGS. 1 to 5 is in this case prolonged in the downstream direction. It thus takes the form of a sleeve 53 whose internal surface 54 is cylindrical.

The flanges 33a and 33b and the brush seal 50 are arranged inside the sleeve 53. The length of the bristles is calculated so that their free ends always bear against the surface 54.

The flexibility and density of the bristles 52 provide perfect sealing even irrespective of the air pressure difference across the two faces of the seal 50 and irrespective of the relative axial and radial displacement between the upstream portion 12a of the external casing 12 and the sleeve 53.

FIG. 7 shows a second embodiment of the invention. Here the body 51 of the brush seal 50 is fastened into the peripheral channel 32 of a ring 60 having a U-shaped cross section, this ring 60 has flanks 33a and 33b delimiting the groove 32, and the body 51 is fastened therein by means of rivets 34. This ring 60, equipped with the seal 50, is subsequently fastened to the periphery of the upstream part 12a of the external casing 12 by welding. It is of course possible for the ring 60 as well as the seal 50 to be sectorized.

FIG. 8 shows a third embodiment of the invention, which differs from that of FIG. 7 by virtue of the fact that the brush seal 50, which may or may not be sectorized, has a metal ring 70 in its radially inner region and this ring may be fastened by welding to the periphery of the upstream part 12a of the external casing 12 of the diffuser grating.

1. A jet engine comprising, from upstream to downstream (the upstream and downstream directions being defined by the direction of circulation of the primary flow), a high-pressure compressor, a diffuser grating and a combustion chamber, said high-pressure compressor comprising an external shell which radially delimits the duct for said primary flow and is connected to an annular structure extending radially outward, said diffuser grating comprising in the axial continuation of said external compressor shell an external casing connected to a rearwardly oriented conical strut delimiting, upstream, the end of said combustion chamber, said strut itself being connected to an external casing shell which extends in the upstream direction and is fastened to said annular structure by fastening means, said strut, said external casing shell and said annular structure defining a cavity around said diffuser grating, air bleed orifices being made in said strut in order to bring the end of the combustion chamber into communication with said cavity, said external casing shell being equipped with air bleed vents, and sealing means being provided between said annular structure and said external diffuser grating casing in order to isolate said cavity from the duct for the primary flow,
wherein the sealing means consist of a brush seal fastened to the periphery of the upstream part of the external casing of the diffuser grating, said seal having bristles which extend radially outward and bear against the internal surface of a cylindrical sleeve which is integral with the annular structure and surrounds said brush seal.

2. The jet engine as claimed in claim 1, wherein the upstream part of said external casing has a groove at its periphery, and the brush seal is fastened into said groove by fastening means.

3. The jet engine as claimed in claim 1, wherein the brush seal is fastened by fastening means into the peripheral groove of a ring having a U-shaped cross section and said ring is fastened by welding to the periphery of the upstream part of said external casing.

4. The jet engine as claimed in claim 1, wherein the brush seal has a metal ring in its radially inner region, and said ring is fastened by welding to the periphery of the upstream part of said external casing.
